(19) United States
(12) Patent Application Publication
(10) Pub. No.: US 2010/0318642 A1
(43) Pub. Date: Dec. 16, 2010

(54) SYSTEM AND METHOD FOR MANAGING AND MONITORING ELECTRONIC COMMUNICATIONS

(76) Inventor: Linda Dozier, Great Falls, VA (US)

Correspondence Address: Nelson Mullins Riley & Scarborough LLP;IP Department, 100 North Tryon Street, 42nd Floor, Charlotte, NC, 28202-4000, US

(21) Appl. No.: 12/718,925

(22) Filed: Mar. 5, 2010

Related U.S. Application Data
(60) Provisional application No. 61/157,897, filed on Mar. 5, 2009.

(51) Int. Cl. G06F 15/16

(52) U.S. Cl. 709/223

(57) ABSTRACT

A system and method for providing and enforcing policy management and access control through a cloud-based computing system to other cloud-based computing systems via application programming interfaces.

### CLAIM OF PRIORITY

The present application claims the benefit of the United States provisional patent application filed on Mar. 5, 2009 by Linda Dozier, entitled “System and Method for Managing and Monitoring Electronic Communications” (Ser. No. 61/157,897), the entire disclosure of which is hereby incorporated by reference for all purposes as if set forth verbatim herein.

### FIELD OF THE INVENTION

The present invention relates generally to electronic communications and, more specifically, to managing and monitoring electronic messages (“email”).

### BACKGROUND OF THE INVENTION

The major components of an email system include a client interface, provisioning and identity management, access control, mail transfer, processing, and storage. Web 1.0 or pre-web mail systems are based on a vertically-integrated set of technology implementing these components, an example of which is illustrated in FIG. 1. These solutions tightly couple the client interface with access control and authorization, mail services, and their processing and storage. Choice of such a system confines the entity or user to a solution based on the technology choices and strategies selected by the solution's vendor. Additionally, these solutions do not generally provide distinctive security, policy management, administrative, curriculum-oriented, and user-oriented features that are necessary for educational users.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a conventional email system;

FIGS. 2 and 3 are diagrammatic representations of an electronic mail system in accordance with an embodiment of the present invention; and

FIGS. 4 and 5 are illustrations of exemplary access policies in accordance with an embodiment of the present invention.

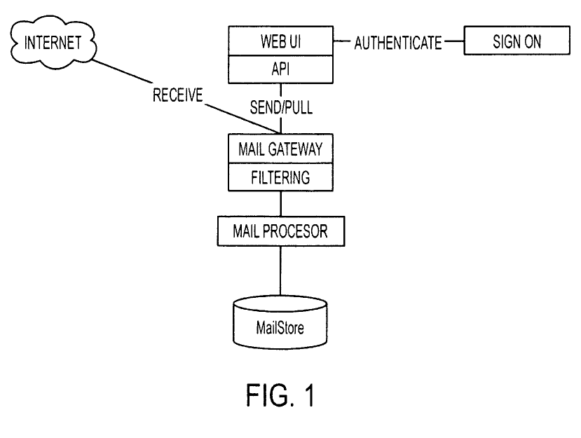

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The systems and methods described herein allow an entity to expand electronic communications capabilities and to open opportunities for educational collaboration between students, parents, and educators in a manner which allows choice integration of market-leading solutions for core capabilities. It should be understood that electronic communications are intended to include all forms of electronic transmissions including those between users, between users and non-users, such as systems or applications, and between non-users. The solutions are integrated into an easy-to-use and easy-to-support application that implements the policy-managed context required for student and school settings. The systems and methods also allow an entity to provide students, parents, and other stakeholders with high-quality, educational content from third-party scientific and educational organizations and institutions.

The electronic communication systems and methods described herein are designed and built for the unique environment of school-based communities that involve children and other stakeholders, such as administrators, educators, and parents, as well as multiple locations and applicable policies. However, it should be understood that the present invention extends to contexts other than education, such as social networking systems without departing from the scope of the present invention. In fact, those of ordinary skill in the art will appreciate that the following description is applicable to any hierarchical-based organization including multi-level enterprises.

The systems and methods serve entire school-based communities, including parents. The translation services and other capabilities embedded into the systems and methods support parent-educator communication in a compelling and beneficial manner. Closely-aligned content and collaborative learning opportunities support electronic mail as a medium for educational interaction as opposed to merely communication. It should be understood that other mediums of electronic transmissions are included within the scope of the present invention. Policy management, based on information, such as relationship (e.g., student-school, parent-student-specific school), in addition to other factors, such as safety and the configurability of policies, sets the presently-described systems and methods apart from the prior art and other competing systems and methods.

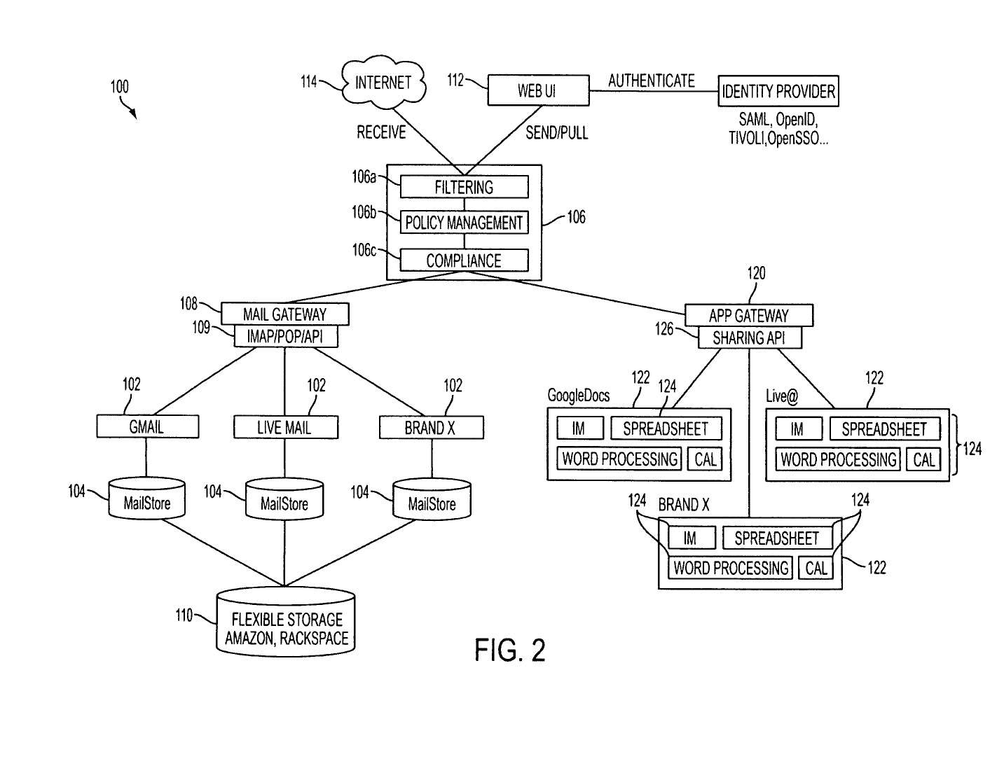

The Internet became a distributed computing platform based on web services with the evolution of Web 2.0. Web 3.0 is emerging as a distributed database platform. FIG. 2 illustrates an electronic communication system 100 based on a Web 2.0/3.0 architecture where each component of the mail system is optimally selected according to customer-driven needs and choices. Referring to FIG. 2, system 100 is a no-cost, robust, scalable, high-availability mail service comprising one or more large-scale mail/storage providers 102. Examples of providers 102 include GMAIL maintained by GOOGLE, INC., LIVE@EDU and HOTMAIL maintained by MICROSOFT CORP., and YAHOO!MAIL maintained by YAHOO INC., although it should be understood that other mail and/or storage providers may be used.

Providers 102 are operatively connected to a compliance, access control, or policy management system 106, which may be an indirect connection via a mail gateway 108. Compliance system 106 is also operatively connected to a wide area network, such as Internet 114. Compliance system 106 includes several modules, including a filtering module 106a, a policy management module 106b, and a compliance module 106c. Each provider 102 is operatively connected to a mail store 104 and may also be operatively connected to a flexible storage 110 either directly or via mail store 104. In the present embodiment, and as illustrated by FIG. 2, each provider 102 is connected to the same flexible storage 110. A user interface (“UI”) 112 is adapted to provide users with access to system 100.

Compliance or policy management system 106 may be a server comprising a processing device and memory but is preferably a cloud-based computing system sharing resources of multiple computers, servers, and systems. As should be understood in the art, a cloud-based system, such as compliance system 106, comprises an abstraction of computer resources from their physical underlying architecture, thereby enabling convenient, on-demand, scalable network access to the shared pool of resources. In this instance, compliance system 106 defines and stores user-defined policies applicable to multiple distinct users, groups, domains, objects, systems, or interactions across a network. In a preferred embodiment, compliance system 106 applies the policies and provides access control to other systems, including other cloud-based systems as described in more detail below. For instance, system 106 defines compliance, transport, and security rules and secures access to providers 102 and 122 by applying the same via gateways 108 and 120 using APIs 109 and 126.

In one embodiment, system 100 additionally comprises an application gateway 120 operatively connected to one or more providers 122. Providers 122 offer, maintain, or otherwise provide one or more services or applications 124. An API 126 provides access between application gateway 120 and the services or applications 124 of providers 122. Although one API 126 is illustrated in FIG. 2 for providing access to multiple service providers 122, it should be understood that multiple APIs may be utilized, each of which is configured to interact with the respective service. It should also be understood that the API may be stored within system 106 or within the applicable system 122 and called from within system 106.

Each provider 122 and application or service 124 may be a server comprising a processing device and memory but is typically a cloud-based computing system providing access to at least one application or service rather than to a particular server, similar to that described above with respect to system 106. Examples of the services and applications 124 offered by providers 122 are described in more detail below. Providers 102 and 122 may also comprise tethered application where the functions of the tethered application are inaccessible or limited to users other than via an API.

It should be understood that the architecture of electronic communication system 100 is based on open web services and data, which provides an entity utilizing the system with the ability to integrate the best-of-breed technology for each service that comprises a complete mail or other service system, thereby allowing the entity to take advantage of how those solutions integrate with closely-related functions (e.g., ease of integration with word processing or other applications). System 100, and, specifically compliance system 106, may be integrated into an existing identity provider for authentication as described in more detail below. Alternatively, system 100 provides its own identity management, which includes monitoring and delegation of administration tasks.

In operation, a user accesses system 100 via UI 112 which may be accomplished by direct connection or via a network, such as Internet 114. All transmissions, emails, or other communications are routed through compliance system 106. Certain basic email functionality and other services usually found hardwired in email and service solutions, such as the “store” and “forward” functions, are implemented using either the LIVE MAIL API (or “Live mAPI”) maintained by MICROSOFT CORP. or using GOOGLE APPS (“GoogleApps”) FOR EDUCATION APIs maintained by GOOGLE, INC. Transmissions are transferred to gateways 108 and 120, which are adapted to interface with one or more providers 102 and 122, such as GoogleApps for Education APIs or Windows Live APIs depending on the entity's or user's choice. Mail store 104 and/or flexible storage 110 may be provided by providers 102 and 122 or by another third-party. In another embodiment, mail store 104 and/or flexible storage 110 are provided by several providers 102, such as both GOOGLE, INC. and MICROSOFT CORP. Such an approach ensures no-cost, scalable, high availability mail processing and storage capabilities. As a result, system 100 provides a free and reliable mail service with the assurance of an open architecture that allows choice now and in the future. In fact, it should be understood from the description herein that system 106 may be configured to provide access to mail providers 102 in a manner such that various mail providers may be added, removed, or replaced without affecting a user's access to system 100 or its functionality.

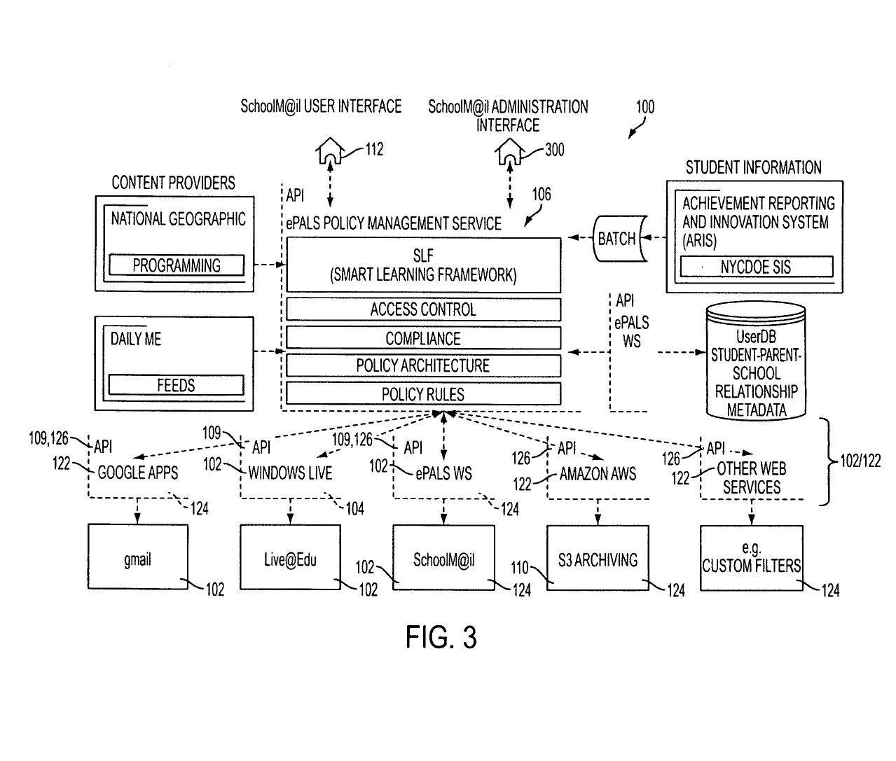

FIG. 3 illustrates system 100 in accordance with another embodiment of the present invention. System 100 comprises a web-based thin client. System 100 is accessed via UI 112 using a standard browser on a computer comprising a processing device and an operating system, such as WINDOWS, MACINTOSH, APPLE, UNIX, or LINUX. The computer is connected to system 100 via a wide area network, such as Internet 114. Alternatively, the computer may be connected to system 100 via an internal or local network, such as that maintained by a school system. All mail and attachments are maintained in the hosting environment in order to minimize movement of data through the external systems of entities and users using system 100.

System 100 includes features standard to email, such as customizable folders and tools to read, compose, forward, and edit messages. Several distinctive features are also included, such as: (1) access control specific to user roles, including student, educator, school administrator, or parent, along with district-wide, policy-managed email capabilities specific to the roles; (2) compliance with the Children's Online Privacy Protection Act (or “COPPA”), the Children's Internet Protection Act (or “CIPA”), and TRUSTe Certification; (3) instant language translation to facilitate communication between the parents, students, and educators; and (4) an architecture that enables integration with large-scale email providers 102, as well as best-of-breed technologies.

System 100 enhances student communication by allowing school districts, administrators, chosen educators, or others to manage policy, control, monitor, and block email messages, unwanted content, and other potential “problems” connected with email or other electronic communications and communication systems. For instance, entities that employ system 100 can (1) control all student transmissions, including emails and messages, and ensure accountable, responsible use by allowing administrators and information technology (“IT”) staff to customize applications according to policies and practices; and (2) establish the rules to block SPAM, student misuse, or other misuse using intuitive web-based controls to manage accounts and emails. System 100 complies with COPPA and CIPA by employing advanced automated message filtering and monitoring systems.

Entities using system 100 can integrate with other entities using system 100 on a global community level, thereby using Web 2.0 collaboration technologies to support 21st century learning experiences. The global community is based on a mature framework with fully programmable API's and a wide range of collaborative tools. Integration within such a global community allows for utilization of a large set of features including wikis, blogs, forum, rich media and video galleries, widgets, integrated ratings and comments, and integration of high quality contextually-relevant content from scientific and educational organizations, institutions, and providers, such as National Geographic.

System 100 comprises the following features: (1) inbox, delete box, and sent box; (2) commands such as read, compose, reply, forward, forward-to-all, and print; (3) ability to add attachments and address book names and start email study groups; (4) flexible policy-managed email capabilities to ensure adherence of policies by all users (can also be integrated with market leading content filter systems); (5) built-in instant language translation to facilitate communication between the parents, students, and educators (resides in the composition as well as received message windows eliminating the need for cut and paste from window to window); (6) virus protection and scanning (integrated and open to integrate best-of-breed solutions, as well as preexisting solutions and systems); (7) anti-spam filtration (integrated and open to integrate best-of-breed solutions and preexisting solutions and systems); (8) spell checker; (9) manuals, frequently asked questions (“FAQs”), and tutorials designed to minimize school district personnel support involvement; (10) compatible with all browsers and computer operating systems; (11) requires little-to-no computer resource allocation; (12) web-based software and access; (13) school- and district-wide solutions for email setup, monitoring, and privacy, as well as content control (integrated and open to integrate best-of-breed solutions and preexisting solutions and systems); (14) free accounts for every student, parent, and administrator; and (15) home-to-school connections by allowing parents to reinforce in-class learning when their children access the same tools at home and at school.

It should be understood that, because access to system 100, and specifically via UI 112, is accomplished by a web-hosted, thin-client, hardware and software requirements necessary to access the system are minimal. Thus, in order to use system 100, users need access to a computer, with an Internet connection, running one of the operating systems identified above, along with a standard web browser such as Internet Explorer, Firefox, Safari, or Mozilla. The browser must be configured to allow “cookies” in order to manage sessions. It should also be understood that all mail processing and other services provided by the system, including translation services, prevention of SPAM, and other content filtering and account management, are performed within compliance system 106 and therefore places no technical requirements beyond operation of a browser with Internet connectivity on users of system 100.

System 100 provides security, policy management, administrative, curriculum-oriented, and user-oriented features that are necessary for educational users, including: (1) monitoring capabilities for a safe and supervised email environment for students; (2) access level controls that define who and how users can communicate within the system; (3) compliance with COPPA, CIPA, and TRUSTe Certification; and (4) highly intuitive, easy-to-use, and classroom-tested administrative and user interfaces.

System 100 utilizes both the functionality provided by the APIs supplied by providers 102 and 122 and by compliance system 106. The combination of UI 112, compliance system 106, and providers 102 and 122 joins access control, policy architecture, and policy rules with large-scale mail store and other service providers. The resulting system 100 provides choice and even greater reliability for customers (now and into the future), without the tedium and cost of managing large-capacity storage, backup, and connectivity. Thus, system 100 uniquely empowers customers and enhances student/parent communication by allowing school districts, administrators, and educators to manage policy and control and monitor and block email messages, unwanted content, and other problems potentially connected with email and other transmission. At the same time, system 100 includes all the advantages of the very large-scale offerings of providers 102 and 122.

In operation, teachers register and complete a profile using system 100 and are then able to connect with other classrooms globally for exchanges, literacy and foreign language skills, and cross cultural exchanges, as well as structured project-based learning modules. Examples of learning modules are set forth in copending U.S. patent applications Ser. Nos. 12/463,266, 12/105,254, 11/937,499, 11/937,497, and 11/937,495, each of which is hereby incorporated by reference in its entirety for all purposes as if set forth verbatim herein. System 100 comprises a projects area that includes a number of focus areas, such as “global warming,” which are designed to assist teachers in incorporating online activities and sharing into their classroom for 21st century skills building. Each project includes a start-to-finish project plan, with elements, calendar, and rubrics to assist teachers in evaluating the students' contribution, understanding, and comprehension of each element in the project.

All interfaces to system 100, including UI 112, are accomplished through industry standard protocols, open data bindings, or published web services, as should be understood by those of ordinary skill in the art. Once an open standards-based framework for data and protocol interoperability has been established, then individual components that meet the requirements for content management, authorization, and/or reporting are evaluated and selected against the established definition of interfaces. It should be understood that this allows selecting, customizing, and integrating low-to-no-cost off-the-shelf components. One of ordinary skill in the art will appreciate that this does not prevent integration of proprietary solutions from third-parties.

The framework of system 100 is a mature platform with fully programmable APIs and a wide range of capabilities. The presentation layer of the platform is loosely coupled from the services layer. The following is a selected list of features of system 100: (1) school-friendly information architecture—the architecture applies school-based constructs to the organization of people, content, and processes. System 100 includes an n-level hierarchical relationship between entities that can be used to represent a state, district, school, classroom, etc. Each entity is a full-group within the social network with all of the rights and capabilities that typically apply. A project or course can be a group that has members, their own forums, blogs, profile, and gallery. An individual may belong to many groups and their role and rights may change from group to group; (2) wikis—an efficient tool for teams to capture, create, and collaborate on projects. With built-in workflow and easy, rich text editing, any user is able to create content that is visible to team members and available for editing and collaborative contributions. Any wiki of the system also includes permissions and moderation tools, structured or unstructured content, and user voting to visibly rank the value of wiki pages; (3) blogs—from public to private web logs, the blogging application of system 100 is multi-faceted and supports thousands of blogs. It is adapted to grow according to the needs of the entities and users utilizing system 100; (4) forums—enable interactive collaboration between individuals and the community. UI 112 includes additional question and answer features that bring verified answers to the top of the thread, providing visibility of valuable information to the reader; (5) rich media and video—media galleries are a core application that displays multiple types of files, images, and videos in a more meaningful way. System 100 integrates video from third-party services such as FLIKR and TEACHERTUBE. Using the ratings and tagging functionality, users can express their opinions and sort media for relevancy; (6) messaging and social streams—if allowed and enabled, an instant message can be transmitted to an individual in the group or to the entire group. The ability to “private message” makes it easy for users to communicate with individuals and with the community at large (including their classmates); (7) widgets—system 100 is enabled with dynamic widget capabilities, which may be used to leverage outside data, to call a custom web service, or to reuse an RSS feed; (8) integrated ratings and comments—allows users to comment on group posts and encourages collaboration across the organization; (9) discoverability of content (such as via RSS and tags)—leverages the accessibility of ingested content with more extensive search capability. Tag clouds assist users in finding relevant content; (10) ease of content creation—system 100 provides easy-to-use content management tools that allow end users to organize and share content. With a WYSIWYG editor, neither technical skills nor developers are required to post student work or curriculum extensions; (11) rich security and permissions model—system 100, and specifically compliance system 106, allows entities using system 100 to determine the entity's access policy and to connect the policy to a role—both at the school construct and even core content object levels. Certain aspects of the “policy” can be made available to be applied by personnel that are not administrators—and that can be set and adjusted without the requirement of being done by technically trained administrative personnel.

As noted above, system 100 can incorporate and integrate content from third-party scientific and educational organizations and institutions, such National Geographic. Tools within system 100 allow this content to be utilized and presented at relevant locations within the system. It should be understood that all of the features, functions, and services described above, including those offered by providers 102 and 122, are accessed through system 106 in order to enforce the policies defined therein for the user(s) and the associated role(s) via APIs 109 and 126 of provides 102 and 122, respectively.

System 100 includes an administrative interface 300 that provides the ability to: (1) create sub-administrators which can be assigned to specific buildings/schools; (2) create and add schools; (3) create and add grades; (4) create and add teacher, student, and parent accounts; (5) determine access levels and filter settings for all accounts set on a global basis or user-by-user; (6) manage users; (7) run reports; (8) reset passwords; and (9) reassign users to different schools or monitors. Thus, the administrative interface and tool is intuitive and offers complete control by the administrator to create, manage, modify, and delete users. These rules and policies are carried out by system 106.

Using UI 112, users may create personal folders to store messages. These folders organize messages according to subject matters chosen by the user. Additionally, UI 112 provides users with the ability to create, manage, and import and export individual contacts and groups of contacts. UI 112 enables users to create a personal address book and define groups within the address book (i.e., classmates, teachers, personal contacts, etc.). A user may import a list of contacts from another address book, such as from a .csv file. Similarly, the user may export the list of contacts from his or her account within system 100 to another mail program. The address book functionality within system 100 allows the user to save a list of email addresses as well as personal information. The address book functionality is adapted to display the full name and email address of persons in the user's list, displayable by email, by nickname, or by group. It allows the user to organize contacts into groups, such as teachers, classmates, parents, or other groups.

System 100 allows users to create and participate in discussion group “forums” that enable interactive collaboration between individuals, chosen groups, and the broader community. UI 112 includes additional question and answer features that bring verified answers to the top of the thread, providing visibility of valuable information to the reader. In one embodiment, system 100 comprises a listserv. System 100 is adapted to integrate with the ICAL program maintained by APPLE INC., the calendar program offered by GOOGLE INC., or the calendar portion of the OUTLOOK or EXCHANGE programs maintained by MICROSOFT CORP. System 100, and specifically UI 112, support reading and composing email messages in plain text, as well as HTML.

System 100 embeds language translation services in each aspect of the system. The open architecture of system 100 allows for API-based implementations with multiple translation solutions allowing the system to utilize the best-in-breed machine translation solutions and, when appropriate, to utilize multiple solutions in order to optimize the number of language pairs supported and the efficacy of the translations themselves. These capabilities are embedded into the write and read flow of the mail.

As a result, entities using system 100 may select from multiple translation solutions in an effort to balance cost and efficacy of the translations. In various embodiments of the present invention, solutions include: (1) utilizing a preexisting translation service embedded in compliance system 106; (2) utilizing another translation solution provided by providers 102 and 122, such as the translation APIs maintained by GOOGLE, INC. or other API-based solutions, such as URDU, BENGALI, or HAITIAN CREIOLE; or (3) any combination of (1) or (2).

System 100 also incorporates text-to-speech functionality in order to assist users with disabilities that are natively supported in the operating system of the user's machine.

It should be understood from the above description that the open architecture described above allows integration of additional components, such as policy managed document services and web applications, examples of which are illustrated in FIGS. 2 and 3.

System 100 and, specifically, compliance system 106 provide advertising standards, policies, and practices. In one embodiment, the standards, policies, and practices are established by a public entity, such as the Public Broadcasting Service, National Geographic, or another third-party. In this manner, advertising and material selected and/or controlled or managed by an administrator or other user may be incorporated into system 100 and presented to its users.

System 100 provides at least two levels of protection for students accessing webmail. System 100 is adapted to allow administrators to set access-level filters that define a communication level available to student accounts. Student access levels are restricted to one of the following options: (1) class/monitor—students are limited to mailing other students who have the same monitor. With this access level, students use email only for internal exercises within the classroom; (2) school—students are limited to mailing students and teachers in the same school. With this access level, students use email only for school-based projects and communication; (3) district—this option, available only if multiple schools are included within system 100, limits students to mailing students and teachers at schools created within the system. With this access level, students use email only for district- and school-based projects and communication; (4) system-level—allows students to communicate with other students with active accounts in the global community; or (5) Internet—this option allows students full email rights to all of the above options as well as the ability to send and receive from outside email accounts.

The second level of security is filter settings. These settings determine the level of monitoring that must be performed prior to the student receiving or sending email. The monitor will be required to approve messages that are to be received or sent dependent upon the following filter setting levels: (1) level 1—the monitor must approve every message sent and received regardless of content; (2) level 2—the monitor receives a copy of every message sent or received, but must approve only those that contain profanity or other predetermined words and/or phrases; (3) level 3—the monitor will only receive messages that contain the predetermined words or phrases. These messages will require approval before reaching their destination; (4) level 4—all content filters are deactivated. The monitor will only receive copies of student messages if system 100 is configured to flag messages with attachments and then only if the message has an attached file.

All mail delivered to user accounts within system 100 pass through multiple filters, checks, and policy rules. Sender addresses are checked against a global list of entities known to send SPAM or other unsolicited emails. System 100 deletes, removes, or quarantines any electronic message or email if the internet protocol (“IP”) address of the originator, sender, or router matches that of an entity on the list. An example of such a list for which system 100 is adapted to use is the SPAMHAUS list maintained by THE SPAMHAUS PROJECT. The SPAMHAUS list is updated multiple times a day via a subscription/connection between the list and system 100.

If mail passes the above-described filters and checks, system 100 then scans the mail for viruses. System 100 then compares the mail to another blacklist, such as the one maintained by SPAMASSASIN, and then compared and/or checked with additional filters such as the RAZOR device offered by VIPUL, the PYZOR software maintained by SOURCEFORGE, the Distributed Checksum Clearinghouse (or “DCC”), and/or other filters and checks known to those of ordinary skill in the art. In one embodiment, if a virus is found, system 100 discards or deletes the mail completely. Alternatively, the mail is quarantined to allow for further investigation. Otherwise, a set of spam score headers are injected into the head of the email. The application looks at those headers to determine whether to deliver to the inbox or the spam box.

One or more firewalls within system 100 are configured to block all ports other than the ports used to transmit http and https information (or Transmission Control Protocol (“TCP”) ports 80 and 443, respectively). Universal Resource Locators (“URLs”) to the administrative backend webpages of the servers are deactivated and replaced with custom administration interfaces and URLs. All community posts are monitored. System 100 is adapted to allow moderators to check every post for content appropriateness before allowing it to appear or be available within system 100. Finally, the architecture of system 100 permits entities using the system to select solutions already used by the respective entity and have each service extended to email or to pick additional best-of-breed services at its discretion and at its expense, if any, to such third parties.

System 100 enables centralized and/or decentralized management control to support a tiered approach to account administration. Once initial data provided by an entity intending to use system 100 has been loaded into one or more of the system's databases, unit tests are executed in order to ensure that users are able to login with the provided passwords, and that each user account is mapped into the correct hierarchy. After the initial load is verified, this process is automated for synchronizing and adding new users.

In one embodiment, an enterprise or educational system is operatively connected to system 106 via a network, such as Internet 114. For instance, a public school district's system information system (“SIS”) is operatively connected to system 106. In such an embodiment, the SIS maintains information about the students and other members, such as teachers and administrators, of the system. Additionally, login and access information to access system 106 for each user of the SIS may be stored in the SIS but is preferably stored within system 106 and linked to the data about the user in the SIS.

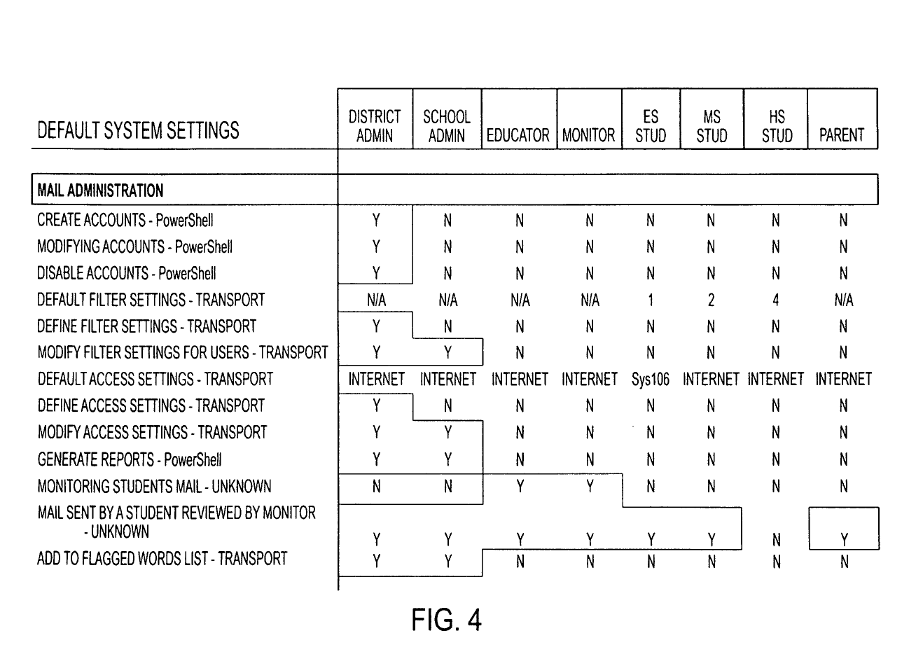

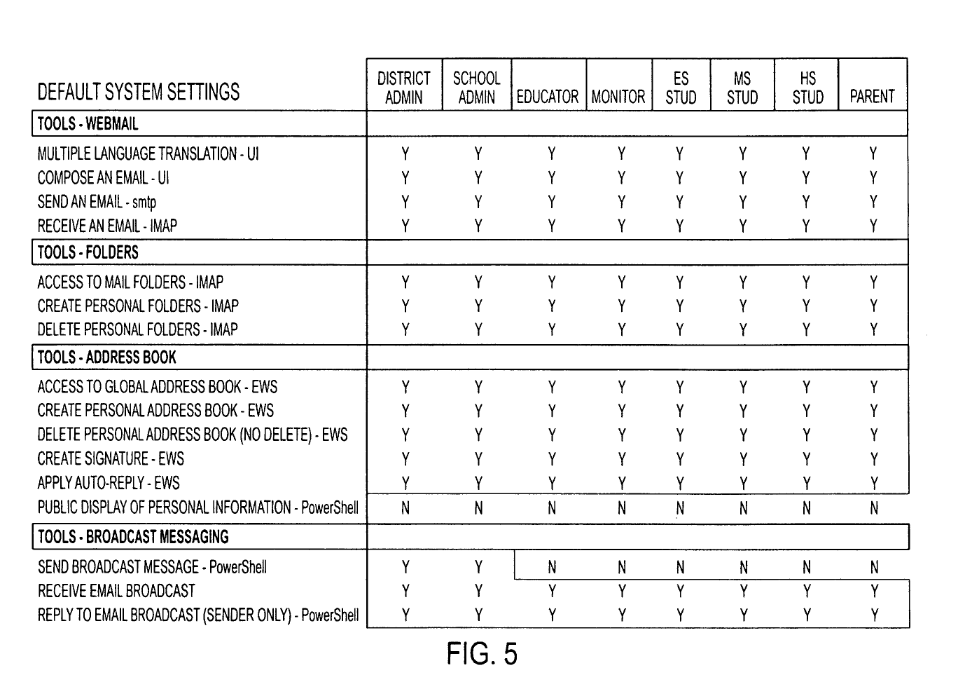

Additionally, the roles, rules, and access policies associated with each user identified in the SIS may be maintained within the SIS but is preferably controlled by system 106. That is, the roles, rules, and access policies applicable to the users of SIS are transported to system 106. The account for each user maintained by system 106 may be linked back to the user's account maintained by the SIS. The policies and rules defined by the SIS are transmitted to system 106 to manage and enforce on top of the services and applications offered by providers 102 and 122. System 106 and, specifically, UI 112 are configured to allow remote management of the policies and rules by authorized users, such as an administrator of the SIS. FIGS. 4 and 5 illustrate charts that identify exemplary policies for an educational entity.

Each user identified in the SIS may access system 106 via UI 112. It should be understood that the SIS may also be configured as a cloud-based computing system. In one embodiment, the SIS may be configured to provide access to system 106 via an API that provides access to the functions and services provided by system 106. System 106 enforces the access control, policies, rules, and roles of the SIS via APIs 109 and 126. For instance, system 106 connects to and enforces these rules on Microsoft Live Mail provider 102 via a secure server(106)-to-server(102) connection via the Exchange Web Services (EWS) Managed API (mAPI).

Students and other users can be added at any time using the batch account management interface of system 100. In this method, school personnel prepare a file to batch upload through the web browser. Once uploaded, system 100 processes the file and transmits the results of the batch process to the uploader via email.

System 100 additionally comprises a “REST” interface to provide entities using the system with additional programmatic control over user management. The REST APIs allow programs remote to system 100 and maintained by the respective entity, such as the SIS, to ad-hoc add, delete, and update users. It will be appreciated by those of ordinary skill that this is convenient for entities and users with automated systems that desire both a highest level of control and a lowest level of latency in database synchronization.

System 100 includes a third option—daily batch processing. In this instance, system 100 processes data files daily. The files contain the changes to be processed in an agreed-upon format, usually the same that was used for the initial data load. Once the changes have been processed, a report on successes and failures is sent to a previously agreed-upon address.

System 100 is adapted to allow users and entities using system 100 to choose whichever interface makes the most sense. The users and entities may use more than one interface if desired. For example, an administrator, teacher, or educator may decide to use the web interface to make an immediate change, rather than wait for the programmatic or batch processes to execute.

System 100 is configured to authenticate users in at least two manners: (1) local, in which credentials are checked against information in the system's databases; or (2) remote, using one or more authentication and access control standards known to those of ordinary skill in the art, such as OPENID, LDAP, or SAML, in order to check credentials against a user-supplied identity provider.

It should be understood from the above description that system 100 is configured to handle the administration of user accounts and user control and access. Accordingly, system 106 manages and handles transport rules, provisioning of users, and user interaction within system 100. That is, system 106 manages access for users, groups, and roles to providers 102 and 122, mail 104, and services 124 via APIs 109 and 126. It should be understood that system 106 can manage access on or at a group, user, application, system, or any other applicable level. For instance, system 106 may disable one specific feature of an application 124 or an entire provider 102 for a single user, multiple users, or entire groups, roles, or outside systems by using the APIs. Furthermore, system 106 may disable a feature of an application 124 or an entire application based on one or more attributes, features, or characteristics of a user or group. For example, system 106 may be configured to disable messaging for any student who's grade point average is below a predetermined threshold or may disable email exchange between two specific classes engaged in a school-sponsored competition while they are engaged in the competition. This may be effected by system 106 because it stores both the policies and data about the users and has access to applications 124 and their features via the APIs.

In one embodiment, system 100 comprises extensive training materials. The included training materials are provided in various user formats, examples of which are as follows: (1) extensive online tutorials (professional and user generated); (2) quick-start guides and manuals in PDF format and downloadable from webmail homepage; (3) handouts and materials for both students and parents; (4) online hosted community configured to allow users to ask questions, download quick start guides and manuals, view online tutorials, gather information, and join discussion forums, as examples.

System 100 also allows system administrators and users to offer unlimited email support. System 100 is adapted to allow users to send emails directly to the support team of system 100 using a link, such as a hypertext link, from the user's respective webmail application. System 100 also comprises a “help” feature available directly from a website located within the system, as well as integration of a help navigation bar available to the users from their email homepage, such as via UI 112.

System 100 additionally comprises a simple-to-use and robust educational tool for creating unified Web-based platforms that administrators, teachers, parents, and students use to achieve academic goals. This includes the ability to create and edit web blogs.

System 100 is also configured to allow incorporation of other programs and services via application gateway 120. Referring again to FIGS. 2 and 3, system 100 incorporates and otherwise uses the functionality and services provided by applications 124 of providers 122 through the use of API 124. That is, API 124 provides a connection between system 100 (and, more specifically, compliance system 106) and applications 124. It should be understood by those of ordinary skill in the art that any application for which an API is provided may be incorporated into system 100. It should be further understood that the result is the combination of the features and aspects of compliance system 106, such as the access control, filtering, and monitoring described above, with one or more of the applications provided by providers 122. For example, system 100, and more specifically API 126, may incorporate document creation and allows each user to select the user's tool of choice. The architecture of system 100 described above supports the integration of GOOGLE APPS provided by GOOGLE INC., the OFFICE SUITE offered by MICROSOFT CORP., or the OPENOFFICE suite of applications created by SUN MICROSYSTEMS in a manner that is compatible with gateway APIs 109 and 126. In addition, system 100 provides the ability to publish documents in a wide variety of formats. For instance, because GOOGLE INC. publishes an API to the GOOGLEDOCS application, the functionality, features, and other aspects of GOOGLEDOCS may be incorporated into system 100. It should be understood by those of ordinary skill in the art that at least one of the results of such a combination is a policy-managed email, document creation, and word processing system. It should be further understood that such a system allows integration of any suitable application, program, or service that is accompanied by an API, regardless of whether the application, program, or service is open source or proprietary in nature.

By way of another example, system 100 is adapted to allow inclusion of additional components through the functionality provided by the APIs described above, such as the GOOGLE APPS or MAPS or MICROSOFT LIVE APIs. That is, the architecture of system 100 is adapted to allow creation of a client interface that operatively connects to the GOOGLE TALK application maintained by GOOGLE INC., the MESSENGER service offered by MICROSOFT CORP., or the AOL Instant Messenger (or “AIM”) maintained by AMERICA ONLINE (“AOL”) LLC. It should be understood by one of ordinary skill in the art that system 100 is configured so that any additional functionality added to system 100, such as instant messaging capability, is operatively connected to compliance system 106 described above. Accordingly, the additional functionality would inherit and include the policy management architecture set forth in detail above.

In a preferred embodiment, users of system 100 may only access the system through system 106. This is typically accomplished via UI 112. Direct access to providers 102 and 122 is prevented. This may be accomplished by disabling direct access to the systems themselves so that only connections to providers 102 and 122 from system 106 are allowed. For instance, certain features offered by the Microsoft Live system (102) are only accessible via API 109, thereby preventing direct access to the system. In such a case, users of system 100 must access the Live system 102 via compliance system 106. This is accomplished by functionality provided by system 106 via programming configured to utilize API 109.

In another embodiment, only direct access to providers 102 and 122 for users of system 100 may be disabled, thereby allowing users not registered with system 100 to access providers 102 and 122 directly. However, users of system 100 are prevented from accessing providers 102 and 122 directly. This may be accomplished by a provider 102 maintaining an identification of the users that are members of system 100. Regardless, the rules, policies, and access control of system 106 is applied to the services, functions, and applications offered by providers 102 and 122. Preferably, all access to system 100 occurs through management system 106.

In another embodiment, the rules, policies, and access control of system 106 are propagated down from the system to providers 102 and 122 to be enforced by the providers. This may be accomplished by the provider requesting the applicable rules and policies for its users from system 106 or by any other suitable means. For instance, domains may be established through which groups of users access an underlying provider 122. Access via the domain automatically identifies the group and applies the policies from system 106 applicable to that group. The domain may be separate from or may be part of the same cloud as the provider.

As described above, system 100 comprises UI 112. Additionally, the APIs described above allow interfaces and/or synchronization with remote systems. For instance, the WINDOWS LIVE API maintained by MICROSOFT CORP. provides the capability to implement synchronization with the OUTLOOK and EXCHANGE programs and services offered by MICROSOFT CORP.

In one embodiment, UI 112 is optimized for access via a desktop web client as described above. It should be understood by those of ordinary skill in the art that UI 112 may be adapted to be executed by mobile devices, such as a smart phone or device, Pocket PC, PDA, etc.

System 100 includes redundancy and redundant and load balancing functionality. System 100 comprises redundant and backup servers, switches, and firewalls. In operation, a request is analyzed by these components of system 100 before being routed to one of the servers or computers tasked with accomplishing the specific request. In one embodiment, all services, including web, ftp, and smtp services, are redundant. In another embodiment, database functionality and databases are also redundant. As should be understood by those of ordinary skill in the art, this allows system 100 to maintain all services and functionality in the event of failure by a component, including failure of a server providing web and database functionality.

System 100 comprises additional tools, including network monitoring software applications. For instance, system 100 incorporates the NAGIOS application in order to monitor the hosts and services of system 100 and alert one or more users or administrators in the event of an issue. System 100 includes the standard functionality provided by the NAGIOS application, including checking and monitoring web servers, databases, machine uptime, and load. System 100 further comprises additional plug-ins that allow checking and monitoring of mail delivery time, mail queue length, and login time. If a component's state changes from normal to critical, system 100, either via the NAGIOS application or the additional plug-ins, transmits electronic communications, including pages, text messages, and emails. System 100 transmits the pages and/or text messages to one or more on-call system administrators, while it transmits emails to the system administration team. System 100 continuously transmits these electronic communications in the event of an issue until the problem has been resolved. System 100 also includes a backup server that backs up, saves, and/or stores the information maintained by the system to preserve the data in an event of any failure. In another embodiment, an additional off-site storage facility, such as the S3 service provided by AMAZON.COM INC., is used to store an additional backup copy of the system's information. In one embodiment, the backup server is the same as flexible storage 110 described above.

It should thus be understood from the above description that system 100 is adapted to provide an overall system that combines the monitoring, filtering, and management of compliance system 106 with other applications and services, such as email programs, word processing suites, instant messaging capabilities, electronic storage facilities, media providers, etc. The result is a system combining a policy management scheme with various applications. It should be understood that the only requirement to apply the features of compliance system 106 to an application or service is an interface, such as an API, to the application or service.

It should be further understood that the above description discloses a system and method for a cloud-based computing system configured to provide policy management and access control for another or multiple cloud-based computing systems for multiple users. Additionally, the cloud-based management system is configured to provide moderation and monitoring of electronic transmissions within the system. These features are accomplished by utilizing the APIs that provide connectivity to the applications and services provided by the other cloud-based computing systems. Accordingly, a multi-tiered cloud computing, rules-based access control system is disclosed. That is, one cloud-based system is configured to manage access and enforce policies on other cloud-based systems. Additionally, the management cloud-based system provides access to users, groups of users, another system, or another cloud-based system to the services and applications provided by the other multiple cloud-based systems.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A system for applying policies to cloud-based computing services comprising:
a policy management cloud that applies user-defined policies to multiple distinct groups, users, domains, objects, or interactions across a network; and
a plurality of computing clouds, wherein each computing cloud provides at least one cloud-based computing service;
wherein the policy management cloud is operatively coupled to the plurality of computing clouds and enforces the user-defined policies to groups, users, domains, objects, or interactions accessible through the at least one cloud-based computing service.

2. The system of claim 1 wherein the user-defined policies reflect distinctions based on end-user attributes and operate on features, functions, data elements, searches, and interfaces.

3. The system of claim 1 wherein the user-defined policies reflect distinctions based on end-user attributes other than access.

4. The system of claim 2 wherein the user-defined attributes are roles, organizational units, location, sender, receiver, position in an organizational hierarchy, group membership, policy, user attributes.

5. The system of claim 4 wherein the user attributes are age, race, social networking status, popularity, ranking, or transmission status.

6. The system of claim 5 wherein the transmission status identifies the user as a spammer.

7. A system for applying policies to cloud-based computing services comprising:
a server that stores user-defined policies applicable to multiple distinct groups, users, domains, objects, or interactions across a network; and
a computing cloud, wherein the computing cloud provides at least one cloud-based computing service;
wherein the server is operatively coupled to the computing cloud and propagates to the computing cloud the user-defined policies applicable to the groups, users, domains, objects, or interactions, wherein at least one of the user-defined policies is recognized by and enforced by the at least one cloud-based computing service.

8. The system of claim 7 wherein the user-defined policies reflect distinctions based on end-user attributes and operate on features, functions, data elements, searches, and interfaces.

9. The system of claim 7 wherein the user-defined policies reflect distinctions based on end-user attributes other than access.

10. The system of claim 8 wherein the user-defined attributes are roles, organizational units, location, sender, receiver, position in an organizational hierarchy, group membership, policy, user attributes.

11. The system of claim 10 wherein the user attributes are age, race, social networking status, popularity, ranking, or transmission status.

12. The system of claim 11 wherein the transmission status identifies the user as a spammer.

13. A method for applying policies to cloud-based computing services:
establishing a policy management cloud configured to apply user-defined policies to multiple distinct groups, users, domains, objects, or interactions across a network;
operatively connecting the policy management cloud to a plurality of computing clouds, wherein each computing cloud provides at least one cloud-based computing service; and
enforcing via the policy management cloud the user-defined policies to groups, users, domains, objects, or interactions accessible through the at least one cloud-based computing service.

14. The method of claim 13 wherein the user-defined policies reflect distinctions based on end-user attributes and operate on features, functions, data elements, searches, and interfaces.

15. The system of claim 13 wherein the user-defined policies reflect distinctions based on end-user attributes other than access.

16. The system of claim 14 wherein the user-defined attributes are roles, organizational units, location, sender, receiver, position in an organizational hierarchy, group membership, policy, user attributes.

17. The system of claim 16 wherein the user attributes are age, race, social networking status, popularity, ranking, or transmission status.

18. The system of claim 17 wherein the transmission status identifies the user as a spammer.
